(19) United States
(12) Patent Application Publication
(10) Pub. No.: US 2026/0049693 A1
(43) Pub. Date: Feb. 19, 2026

(54) CRYOGENIC LIQUID STORAGE APPARATUS

(71) Applicants: Hyundai Motor Company, Seoul (KR); Kia Corporation, Seoul (KR)

(72) Inventor: Jin Young Heo, Hwaseong-si (KR)

(21) Appl. No.: 19/016,192

(22) Filed: Jan. 10, 2025

(30) Foreign Application Priority Data
Aug. 14, 2024 (KR) 10-2024-0109333

(51) Int. Cl. F17C 5/02

(52) U.S. Cl. CPC F17C 5/02; F17C 2201/0109; F17C 2203/0391; F17C 2203/0629; F17C 2205/0355; F17C 2221/012; F17C 2223/0161

(57) ABSTRACT

A cryogenic liquid storage apparatus can include a storage container including an inner container configured to accommodate a cryogenic liquid, and an outer container configured to surround a periphery of the inner container, an extraction pipe having one end connected to the inner container, and the other end exposed to the outside of the outer container, the extraction pipe can be configured to selectively extract the cryogenic liquid to the outside, and a radiation-blocking member can be connected to the extraction pipe, configured to transfer and receive heat to and from the extraction pipe, and provided between the inner container and the outer container, thereby obtaining an advantageous effect of improving efficiency in storing hydrogen.

### CROSS-REFERENCE TO RELATED APPLICATIONS

This application claims priority to and the benefit of Korean Patent Application No. 10-2024-0109333 filed in the Korean Intellectual Property Office on Aug. 14, 2024, the entire contents of which are incorporated herein by reference.

### TECHNICAL FIELD

The present disclosure relates to a cryogenic liquid storage apparatus.

### BACKGROUND

A fuel cell system refers to a system that produces electrical energy by use of a redox reaction between hydrogen and oxygen. Research and development have been consistently performed on the fuel cell system as an alternative capable of solving global environmental issues.

Recently, to increase an energy storage density per unit volume of fuel (e.g., hydrogen) used for the fuel cell system, various attempts have been made to store hydrogen in a liquid state (liquid hydrogen) at cryogenic temperatures (e.g., 20 to 33 K) in a storage container and supply the fuel cell stack with the hydrogen (liquid hydrogen or gaseous hydrogen) stored in the storage container.

To improve efficiency in storing the cryogenic fluid and ensure safety and reliability, it is necessary to minimize an increase in pressure of the cryogenic fluid caused by heat introduced into the cryogenic fluid from the outside of the storage container.

In particular, when pressure of hydrogen increases as heat is applied to the storage container (the pressure is increased by vaporization of liquid hydrogen), there is a problem in that the amount of hydrogen discharged from the storage container (the amount of loss of hydrogen) increases and a non-loss hydrogen storage period (dormancy, a period for which hydrogen can be stored in the storage container without being discharged) decreases.

Therefore, recently, various studies have been conducted to ensure thermal insulation performance of the storage container and improve efficiency in storing the cryogenic liquid, but the study results are still insufficient. Accordingly, there is a need to develop a technology to ensure thermal insulation performance of the storage container and improve efficiency in storing the cryogenic liquid.

### SUMMARY

The present disclosure relates to a cryogenic liquid storage apparatus, and more particularly, to a cryogenic liquid storage apparatus capable of improving efficiency in storing a cryogenic liquid.

An embodiment of the present disclosure can provide a cryogenic liquid storage apparatus capable of ensuring thermal insulation performance of a storage container and improving efficiency in storing a cryogenic liquid.

In particular, an embodiment of the present disclosure can ensure the thermal insulation performance of the storage container by blocking an inflow of radiant heat into an inner container from an outer container and cooling a radiation-blocking member configured to block radiant heat.

Among other things, an embodiment of the present disclosure can improve the thermal insulation performance by transferring cold energy of a cryogenic liquid, which moves along an extraction pipe, to a portion between the inner container and the outer container by use of the radiation-blocking member.

An embodiment of the present disclosure can simplify a structure and improve a degree of design freedom and spatial utilization.

An embodiment of the present disclosure can suppress an excessive increase in temperature (pressure) and excessive vaporization of the cryogenic liquid and suppress an excessive increase in pressure (excessive expansion) of the inner container.

An embodiment of the present disclosure can ensure durability and safety, minimize a loss of hydrogen (the discharge amount of hydrogen), and maximally delay a time point of a loss of hydrogen (extend a non-loss hydrogen storage period).

Advantages to be achieved by embodiments are not necessarily limited to the above-mentioned advantages, but also include advantages that may be understood from the example solutions or example embodiments described below.

An example embodiment of the present disclosure can provide a cryogenic liquid storage apparatus, which can include: a storage container including an inner container configured to accommodate a cryogenic liquid, and an outer container configured to surround a periphery of the inner container; an extraction pipe having one end connected to the inner container, and the other end exposed to the outside of the outer container, the extraction pipe being configured to selectively extract the cryogenic liquid to the outside; and a radiation-blocking member connected to the extraction pipe, configured to transfer and receive heat to and from the extraction pipe, and provided between the inner container and the outer container.

An embodiment of the present disclosure can ensure thermal insulation performance of the storage container and improve efficiency in storing a cryogenic liquid.

That is, to improve efficiency in storing the cryogenic fluid and ensure safety and reliability, it can be necessary to minimize an increase in pressure of the cryogenic fluid caused by heat introduced into the cryogenic fluid from the outside of the storage container. In particular, when pressure of hydrogen increases as heat is applied to the storage container (the pressure can be increased by vaporization of liquid hydrogen), there can be a problem in that the amount of hydrogen discharged from the storage container (the amount of loss of hydrogen) can increase and a non-loss hydrogen storage period (dormancy, a period for which hydrogen can be stored in the storage container without being discharged) can decrease.

In contrast, in an embodiment of the present disclosure, the radiation-blocking member may block an inflow of radiant heat into the inner container from the outer container, and the radiation-blocking member may be cooled by the cold energy of the cryogenic liquid. Therefore, an embodiment of the present disclosure can obtain an advantageous effect of ensuring the thermal insulation performance of the storage container and improving the efficiency in storing the cryogenic liquid.

Among other things, in an embodiment of the present disclosure, the radiation-blocking member may block an inflow of radiant heat into the inner container from the outer container, and the cold energy of the cryogenic liquid, which moves along the extraction pipe, may be transferred to the portion between the inner container and the outer container along the radiation-blocking member. Therefore, an embodiment of the present disclosure can obtain an advantageous effect of improving the thermal insulation performance of the storage container and improving the efficiency in storing the cryogenic liquid.

Therefore, an embodiment of the present disclosure can suppress an unnecessary increase in temperature and excessive vaporization of the cryogenic liquid due to heat applied from the outside of the storage container. Therefore, an embodiment of the present disclosure can obtain an advantageous effect of suppressing an excessive increase in pressure in the storage container, minimizing the discharge amount of hydrogen to be discharged from the storage container (wasted hydrogen), and maximally delaying a time point of a loss of hydrogen (extending a non-loss hydrogen storage period).

According to an example embodiment of the present disclosure, the inner container may include a cylinder part, a first side part provided at one end of the cylinder part and having a dome shape, and a second side part provided at the other end of the cylinder part and having a dome shape.

According to an example embodiment of the present disclosure, the cryogenic liquid storage apparatus may include a thermal insulator provided between the inner container and the outer container and configured to surround the periphery of the inner container.

According to an example embodiment of the present disclosure, the cryogenic liquid storage apparatus may include a vacuum thermal insulation layer defined between the inner container and the outer container.

As described above, according to an embodiment of the present disclosure, the vacuum thermal insulation layer for performing vacuum thermal insulation (vacuum insulation) may be provided between the inner container and the outer container. Therefore, an embodiment of the present disclosure can obtain an advantageous effect of sufficiently ensuring thermal insulation performance (cryogenic thermal insulation performance) and minimizing evaporation (vaporization) of the liquid hydrogen caused by a heat inflow.

The extraction pipe may be connected to various points on the inner container in accordance with required conditions and design specifications.

According to an example embodiment of the present disclosure, the extraction pipe may be connected to at least any one of two opposite ends of the inner container based on a longitudinal direction of the inner container.

As described above, in an embodiment of the present disclosure, the extraction pipe may be provided at the end of the inner container based on the longitudinal direction instead of being provided on the cylinder part of the inner container, such that a space required to mount the extraction pipe may be minimized. Therefore, an embodiment of the present disclosure can obtain an advantageous effect of maximizing a hydrogen storage density of the storage container, minimizing a deterioration in spatial utilization and a decrease in volume of the vacuum thermal insulation layer caused by the arrangement of the extraction pipe, and minimizing a deterioration in thermal insulation performance caused by the extraction pipe.

The extraction pipe may have various structures capable of selectively discharging the cryogenic fluid to the outside of the storage container.

According to an example embodiment of the present disclosure, the extraction pipe may include a first spiral pipe portion connected to the inner container, and a second spiral pipe portion continuously connected to an end of the first spiral pipe portion and configured to surround a periphery of the first spiral pipe portion.

According to an example embodiment of the present disclosure, the first spiral pipe portion and the second spiral pipe portion may be configured to define a continuous quadrangular spiral shape.

As described above, in an embodiment of the present disclosure, the extraction pipe may be constituted by continuously connecting the first spiral pipe portion and the second spiral pipe portion each having a spiral shape (e.g., a quadrangular spiral shape), such that a sufficient length of the extraction pipe (a length capable of minimizing an inflow of external heat) may be ensured. Therefore, an embodiment of the present disclosure can obtain an advantageous effect of minimizing a space occupied by the first spiral pipe portion and the second spiral pipe portion and ensuring sufficient contact areas (heat transfer areas) of the first spiral pipe portion and the second spiral pipe portion with respect to the radiation-blocking member.

According to an embodiment of the present disclosure, the first spiral pipe portion and the second spiral pipe portion may each be configured to have a circular spiral shape.

The radiation-blocking member may have various structures capable of blocking an inflow of radiant heat into the inner container from the outer container and transferring the cold energy of the cryogenic liquid, which moves along the extraction pipe, to the portion between the inner container and the outer container.

According to an example embodiment of the present disclosure, the radiation-blocking member may be connected to at least any one of the first spiral pipe portion and the second spiral pipe portion.

The radiation-blocking member may be made of various materials capable of blocking radiant heat and having thermal conductivity.

According to an example embodiment of the present disclosure, the radiation-blocking member may be made of thermally conductive foil.

As described above, in an embodiment of the present disclosure, the radiation-blocking member may be configured by using the thermally conductive foil with a very small thickness, such that a space occupied by the radiation-blocking member may be minimized. Therefore, an embodiment of the present disclosure can obtain an advantageous effect of ensuring the spatial utilization of the vacuum thermal insulation layer (ensuring a space between the inner container and the outer container) and minimizing deformation (compression) of or damage to the thermal insulator caused by the radiation-blocking member.

The radiation-blocking member may have various structures in accordance with required conditions and design specifications.

According to an example embodiment of the present disclosure, the radiation-blocking member may be continuously provided in the longitudinal direction of the inner container.

According to an example embodiment of the present disclosure, the extraction pipe may include a non-surface-treated region, and a surface-treated region having lower surface roughness than the non-surface-treated region. The radiation-blocking member may be connected (attached) to the surface-treated region.

As described above, in an embodiment of the present disclosure, the radiation-blocking member may be connected to the surface-treated region with relatively low surface roughness, such that the extraction pipe and the radiation-blocking member may be attached to each other as tightly as possible, and contact resistance between the extraction pipe and the radiation-blocking member may be minimized. Therefore, an embodiment of the present disclosure can obtain an advantageous effect of further improving the cold energy restoring property of the radiation-blocking member and improving the thermal insulation performance.

According to an example embodiment of the present disclosure, the radiation-blocking member may include a first blocking member connected to the first spiral pipe portion and stacked to be tightly attached to an inner surface of the thermal insulator that faces the inner container, and a second blocking member connected to the second spiral pipe portion and stacked to be tightly attached to an outer surface of the thermal insulator.

The second spiral pipe portion can be connected to a downstream side of the first spiral pipe portion (the cryogenic liquid is heated by heat exchange while moving along the first spiral pipe portion and then moves along the second spiral pipe portion), such that the first blocking member connected to the first spiral pipe portion has a relatively lower temperature than the second blocking member connected to the second spiral pipe portion. According to an embodiment of the present disclosure, the first blocking member may be connected to the inner surface of the thermal insulator, and the second blocking member may be connected to the outer surface of the thermal insulator, such that relatively low-temperature cold energy may be transferred to the inner surface of the thermal insulator, and relatively high-temperature cold energy may be transferred to the outer surface of the thermal insulator in response to a temperature gradient in a thickness direction of the thermal insulator (a phenomenon in which a temperature of the outer surface of the thermal insulator is higher than a temperature of the inner surface of the thermal insulator). Therefore, an embodiment of the present disclosure can obtain an advantageous effect of maximizing the utilization of the cold energy and further improving the thermal insulation performance during the extraction of the cryogenic liquid.

According to an example embodiment of the present disclosure, the cryogenic liquid storage apparatus may include an energy storage member connected to the radiation-blocking member, configured to exchange heat with the radiation-blocking member, and provided between the outer container and the inner container.

As described above, in an embodiment of the present disclosure, the energy storage member may be provided between the outer container and the inner container, and the cold energy transferred along the radiation-blocking member may be stored in the energy storage member, such that the cold energy may be consistently stored even in case that the temperature of the radiation-blocking member is sufficiently decreased. Further, even though the cryogenic liquid is not discharged (e.g., when a vehicle is parked), the thermal insulation performance of the storage container may be stably maintained by using the cold energy stored in the energy storage member.

The energy storage member may have various structures in accordance with required conditions and design specifications.

According to an example embodiment of the present disclosure, the energy storage member may be tightly attached to and surround an outer surface of at least any one of the first side part and the second side part.

According to an example embodiment of the present disclosure, the cryogenic liquid storage apparatus may include a support configured to support the inner container on the outer container.

The support may have various structures capable of supporting the inner container on the outer container.

According to an example embodiment of the present disclosure, the support may support an end of at least any one of the first side part and the second side part on the outer container.

According to an example embodiment of the present disclosure, the cryogenic liquid storage apparatus may include a support member having one end connected to the support, and the other end connected to the energy storage member. The energy storage member may be supported by use of the support.

As described above, in an embodiment of the present disclosure, the energy storage member may be supported by use of the support configured to support the inner container on the outer container. Therefore, an embodiment of the present disclosure can obtain an advantageous effect of stably maintaining the arrangement state of the energy storage member and minimizing a structure and space for supporting the energy storage member.

### BRIEF DESCRIPTION OF THE DRAWINGS

FIG. 1 is a view for explaining a cryogenic liquid storage apparatus according to an embodiment of the present disclosure.

FIG. 2 is a view for explaining a radiation-blocking member of a cryogenic liquid storage apparatus according to an embodiment of the present disclosure.

FIG. 3 is a view for explaining a modified example of an extraction pipe of a cryogenic liquid storage apparatus according to an embodiment of the present disclosure.

FIG. 4 is a view for explaining a first blocking member and a second blocking member of a cryogenic liquid storage apparatus according to an embodiment of the present disclosure.

FIG. 5 is a view for explaining an energy storage member of a cryogenic liquid storage apparatus according to an embodiment of the present disclosure.

FIG. 6 is a view for explaining an energy storage member of a cryogenic liquid storage apparatus according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings.

However, the technical spirit of the present disclosure is not necessarily limited to example embodiments described herein but may be implemented in various different forms. One or more of the constituent elements in the example embodiments may be selectively combined and substituted for use within the scopes of the technical spirit of the present disclosure.

Unless otherwise specifically and explicitly defined and stated, terms (including technical and scientific terms) used in the example embodiments of the present disclosure may be construed as a meaning that may be commonly understood by the person with ordinary skill in the art to which the present disclosure pertains. Meanings of commonly used terms, such as the terms defined in dictionaries, may be interpreted in consideration of the contextual meanings of the related technology.

Terms used in the example embodiments of the present disclosure can be for explaining the example embodiments, not necessarily for limiting the present disclosure.

In the present specification, unless particularly stated otherwise, a singular form may also include a plural form. The expression “at least one (or one or more) of A, B, and C” may include one or more of all combinations that can be made by combining A, B, and C.

Terms such as “first,” “second,” “A,” “B,” “(a),” and “(b)” may be used to describe constituent elements of example embodiments of the present disclosure.

These terms can be used merely for the purpose of discriminating one constituent element from another constituent element, and the nature, the sequences, or the orders of the constituent elements are not necessarily limited by such terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

The expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

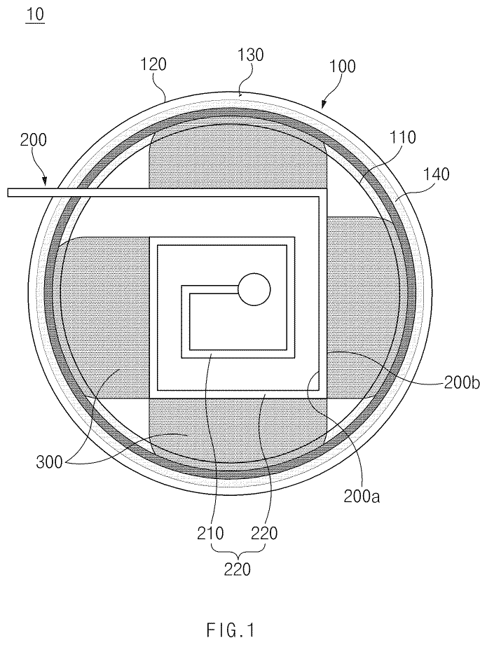

With reference to FIGS. 1 to 6, a cryogenic liquid storage apparatus 10 according to an embodiment of the present disclosure can include: a storage container 100 can include an inner container 110 configured to accommodate a cryogenic liquid, and an outer container 120 configured to surround a periphery of the inner container 110; an extraction pipe 200 having one end connected to the inner container 110 and the other end exposed to the outside of the outer container 120, and the extraction pipe 200 can be configured to selectively extract the cryogenic liquid to the outside; and a radiation-blocking member 300 can be connected to the extraction pipe 200, configured to transfer and receive heat to and from the extraction pipe 200, and provided between the inner container 110 and the outer container 120.

For reference, the cryogenic liquid storage apparatus 10 according to an embodiment of the present disclosure may be used to store various objects in accordance with required conditions and design specifications. An embodiment of the present disclosure is not restricted or limited by the type and properties of the object.

For example, the cryogenic liquid storage apparatus 10 according to an embodiment of the present disclosure may be used to store fuel (e.g., liquid hydrogen) used for mobility vehicles such as fuel cell electric vehicles (e.g., passenger vehicles or commercial vehicles), ships, and aircraft to which a fuel cell system is applied.

The storage container 100 can be provided to store liquid hydrogen (cryogenic liquid hydrogen) used for the fuel cell stack (not illustrated).

Hereinafter, an example embodiment will be described in which the cryogenic liquid storage apparatus 10 includes only the single storage container 100. According to an embodiment of the present disclosure, the cryogenic liquid storage apparatus may include a plurality of storage containers configured to independently store cryogenic liquids.

The storage container 100 may have various structures capable of storing the liquid hydrogen (e.g., at −253° C. based on atmospheric pressure). An embodiment of the present disclosure is not restricted or limited by the type and structure of the storage container 100.

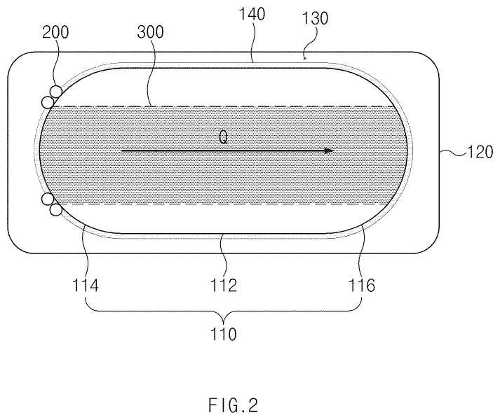

With reference to FIGS. 1 and 2, according to an example embodiment of the present disclosure, the storage container 100 may include the inner container 110 having an accommodation space for accommodating the cryogenic liquid, and the outer container 120 configured to surround the periphery of the inner container 110.

The inner container 110 and the outer container 120, which constitute the storage container 100, may be variously changed in structure and material in accordance with required conditions and design specifications. An embodiment of the present disclosure is not restricted or limited by the structures and materials of the inner container 110 and the outer container 120.

For example, the inner container 110 and the outer container 120 may each have a hollow structure having a storage space therein (e.g., a structure having a circular cross-section). According to an embodiment of the present disclosure, the inner container and the outer container may each have a quadrangular cross-sectional shape or other cross-sectional shapes.

According to an example embodiment of the present disclosure, the inner container 110 may include a cylinder part 112, a first side part 114 provided at one end of the cylinder part 112 and having a dome shape, and a second side part 116 provided at the other end of the cylinder part 112 and having a dome shape.

For example, the cylinder part 112 may have an approximately hollow cylindrical shape. The first side part 114 having a dome shape may be integrally provided at one end (a left end based on FIG. 2) of the cylinder part 112. The second side part 116 having a dome shape may be integrally provided at the other end (a right end based on FIG. 2) of the cylinder part 112.

According to an example embodiment of the present disclosure, the cryogenic liquid storage apparatus 10 may include a vacuum thermal insulation layer 130 defined between the inner container 110 and the outer container 120.

The vacuum thermal insulation layer 130 may be defined between the inner container 110 and the outer container 120 and perform vacuum thermal insulation (vacuum insulation). A thickness of the vacuum thermal insulation layer 130 (a distance between the inner container 110 and the outer container 120) may be variously changed in accordance with required conditions and design specifications.

As described above, according to an embodiment of the present disclosure, the vacuum thermal insulation layer 130 for performing vacuum thermal insulation (vacuum insulation) may be provided between the inner container 110 and the outer container 120. Therefore, an embodiment of the present disclosure can obtain an advantageous effect of sufficiently ensuring thermal insulation performance (cryogenic thermal insulation performance) and minimizing evaporation (vaporization) of the liquid hydrogen caused by a heat inflow.

According to an example embodiment of the present disclosure, the cryogenic liquid storage apparatus 10 may include a thermal insulator 140 provided between the inner container 110 and the outer container 120 and configured to surround the periphery of the inner container 110.

For example, the thermal insulator 140 may be provided to surround a peripheral surface of the inner container 110 and tightly attached to the peripheral surface of the inner container 110.

Various thermal insulation materials may be used as the thermal insulator 140 in accordance with required conditions and design specifications. An embodiment of the present disclosure is not restricted or limited by the type and structure of the thermal insulator 140.

Hereinafter, an example embodiment will be described in which a typical multilayer insulator (MLI) is used as the thermal insulator 140.

The extraction pipe 200 can be configured to selectively discharge the cryogenic fluid (hydrogen), which is stored in the inner container 110, to the outside of the storage container 100 when an internal pressure of the inner container 110 increases to a predetermined pressure or higher.

More specifically, one end of the extraction pipe 200 may be connected to the inner container 110, and the other end of the extraction pipe 200 may be exposed to the outside of the outer container 120.

The extraction pipe 200 may be connected to various points on the inner container 110 in accordance with required conditions and design specifications. An embodiment of the present disclosure is not restricted or limited by the position at which the extraction pipe 200 is connected to the inner container 110.

According to an example embodiment of the present disclosure, the extraction pipe 200 may be connected to at least any one of two opposite ends of the inner container 110 based on a longitudinal direction of the inner container 110.

For example, with reference to FIGS. 1 and 2, the extraction pipe 200 may be connected to an outermost peripheral end of the first side part 114.

As described above, in an embodiment of the present disclosure, the extraction pipe 200 may be provided at the end of the inner container 110 based on the longitudinal direction instead of being provided on the cylinder part 112 of the inner container 110, such that a space required to mount the extraction pipe 200 may be minimized. Therefore, an embodiment of the present disclosure can obtain an advantageous effect of maximizing a hydrogen storage density of the storage container 100, minimizing a deterioration in spatial utilization and a decrease in volume of the vacuum thermal insulation layer 130 caused by the arrangement of the extraction pipe 200, and minimizing a deterioration in thermal insulation performance caused by the extraction pipe 200.

The extraction pipe 200 may have various structures capable of selectively discharging the cryogenic fluid to the outside of the storage container 100. An embodiment of the present disclosure is not restricted or limited by the structure and shape of the extraction pipe 200.

According to an example embodiment of the present disclosure, the extraction pipe 200 may include a first spiral pipe portion 210 connected to the inner container 110, and a second spiral pipe portion 220 continuously connected to an end of the first spiral pipe portion 210 and configured to surround a periphery of the first spiral pipe portion 210.

According to an example embodiment of the present disclosure, the first spiral pipe portion 210 and the second spiral pipe portion 220 may be configured to define a continuous quadrangular spiral shape.

As described above, in an embodiment of the present disclosure, the extraction pipe 200 may be constituted by continuously connecting the first spiral pipe portion 210 and the second spiral pipe portion 220 each having a spiral shape (e.g., a quadrangular spiral shape), such that a sufficient length of the extraction pipe 200 (a length capable of minimizing an inflow of external heat) may be ensured. Therefore, an embodiment of the present disclosure can obtain an advantageous effect of minimizing a space occupied by the first spiral pipe portion 210 and the second spiral pipe portion 220 and ensuring sufficient contact areas (heat transfer areas) of the first spiral pipe portion 210 and the second spiral pipe portion 220 with respect to the radiation-blocking member 300.

In an embodiment of the present disclosure illustrated and described above, the example has been described in which the first spiral pipe portion 210 and the second spiral pipe portion 220 each have a quadrangular spiral shape. However, according to another embodiment of the present disclosure, the first spiral pipe portion 210 and the second spiral pipe portion 220 may each have a circular spiral shape. Alternatively, the first spiral pipe portion and the second spiral pipe portion may each have a triangular spiral shape or other spiral shapes.

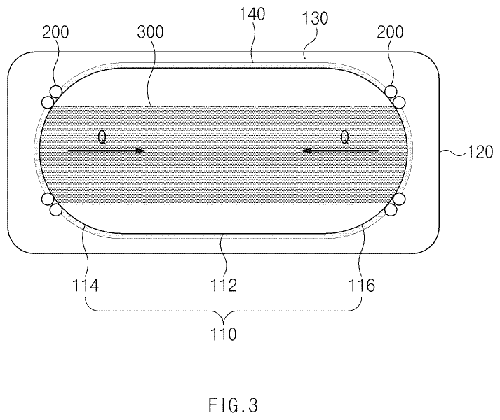

In an embodiment of the present disclosure illustrated and described above, the example has been described in which the extraction pipe 200 is provided at one end of the inner container 110 based on the longitudinal direction. However, according to an embodiment of the present disclosure, as illustrated in FIG. 3, the extraction pipes 200 may be connected to the two opposite ends of the inner container 110 based on the longitudinal direction, and the radiation-blocking members 300 may be respectively connected to the extraction pipes 200.

The radiation-blocking member 300 can be provided between the inner container 110 and the outer container 120, connected to the extraction pipe 200, and configured to transfer and receive heat to and from the extraction pipe 200.

The radiation-blocking member 300 can be configured to block an inflow of radiant heat into the inner container 110 from the outer container 120 and transfer cold energy Q of the cryogenic liquid, which moves along the extraction pipe 200, to a portion between the inner container 110 and the outer container 120.

According to an example embodiment of the present disclosure, the radiation-blocking member 300 may be tightly attached to the thermal insulator 140. The cold energy of the cryogenic liquid may be transferred to the thermal insulator 140 along the radiation-blocking member 300, thereby cooling the thermal insulator 140.

The radiation-blocking member 300 may have various structures capable of blocking an inflow of radiant heat into the inner container 110 from the outer container 120 and transferring the cold energy Q of the cryogenic liquid, which moves along the extraction pipe 200, to the portion between the inner container 110 and the outer container 120. An embodiment of the present disclosure is not restricted or limited by the type and structure of the radiation-blocking member 300.

For example, the radiation-blocking member 300 may be connected to at least any one of the first spiral pipe portion 210 and the second spiral pipe portion 220. Hereinafter, an example embodiment will be described in which the radiation-blocking member 300 is connected to the second spiral pipe portion 220 along an outer periphery of the second spiral pipe portion 220.

According to an embodiment of the present disclosure, the radiation-blocking member may be connected only to the first spiral pipe portion, or the radiation-blocking member may be connected only to a section of a part of a periphery of the second spiral pipe portion (or the first spiral pipe portion).

The radiation-blocking member 300 may be made of various materials capable of blocking radiant heat and having thermal conductivity. An embodiment of the present disclosure is not restricted or limited by the type and properties of the radiation-blocking member 300.

According to an example embodiment of the present disclosure, the radiation-blocking member 300 may be configured as thermally conductive foil (e.g., metal foil) with a very small thickness (e.g., several to several tens of micrometers (μm)).

In such case, the configuration in which the radiation-blocking member 300 includes the thermally conductive foil can be defined as including both a configuration in which the radiation-blocking member 300 includes only a single sheet of thermally conductive foil and a configuration in which the radiation-blocking member 300 includes a plurality of sheets of thermally conductive foil stacked in a reference direction.

As described above, in an embodiment of the present disclosure, the radiation-blocking member 300 may be configured by using the thermally conductive foil with a very small thickness, such that a space occupied by the radiation-blocking member 300 may be minimized. Therefore, an embodiment of the present disclosure can obtain an advantageous effect of ensuring the spatial utilization of the vacuum thermal insulation layer 130 (ensuring a space between the inner container and the outer container) and minimizing deformation (compression) of or damage to the thermal insulator 140 caused by the radiation-blocking member 300.

According to an example embodiment of the present disclosure, foil made of high-purity silver or copper may be used as the radiation-blocking member 300.

High-purity metal, such as silver or copper, has thermal conductivity several tens of times higher in a cryogenic region (e.g., 20K) than in a room-temperature region. Therefore, the high-purity metal may more effectively transfer the cold energy of the cryogenic liquid (liquid hydrogen).

The radiation-blocking member 300 may have various structures in accordance with required conditions and design specifications. An embodiment of the present disclosure is not restricted or limited by the structure and shape of the radiation-blocking member 300.

For example, the radiation-blocking member 300 may have a continuous band shape in the longitudinal direction of the inner container 110. In particular, the radiation-blocking member 300 may have a length (a length in the longitudinal direction) corresponding to the inner container 110.

According to an example embodiment of the present disclosure, the extraction pipe 200 may include a non-surface-treated region 200a, and a surface-treated region 200b having lower surface roughness than the non-surface-treated region 200a. The radiation-blocking member 300 may be connected (attached) to the surface-treated region 200b.

The surface-treated region 200b may be provided by treating the surface of the extraction pipe 200 (minimizing roughness) by use of a typical surface treatment process such as electro-polishing and buffing. However, an embodiment of the present disclosure is not restricted or limited by the process of treating the surface of the surface-treated region 200b.

As described above, in an embodiment of the present disclosure, the radiation-blocking member 300 may be connected to the surface-treated region 200b with relatively low surface roughness, such that the extraction pipe 200 and the radiation-blocking member 300 may be attached to each other as tightly as possible, and contact resistance between the extraction pipe 200 and the radiation-blocking member 300 may be minimized. Therefore, an embodiment of the present disclosure can obtain an advantageous effect of further improving the cold energy restoring property of the radiation-blocking member 300 and improving the thermal insulation performance.

According to the example embodiment of the present disclosure, the radiation-blocking member 300 may be compressed and attached to the surface of the extraction pipe 200 by using a heat transfer medium (not illustrated), such as thermal conductive grease, applied onto an interface (contact surface) between the extraction pipe 200 and the radiation-blocking member 300 or using a compression device (not illustrated) such as a compression clip.

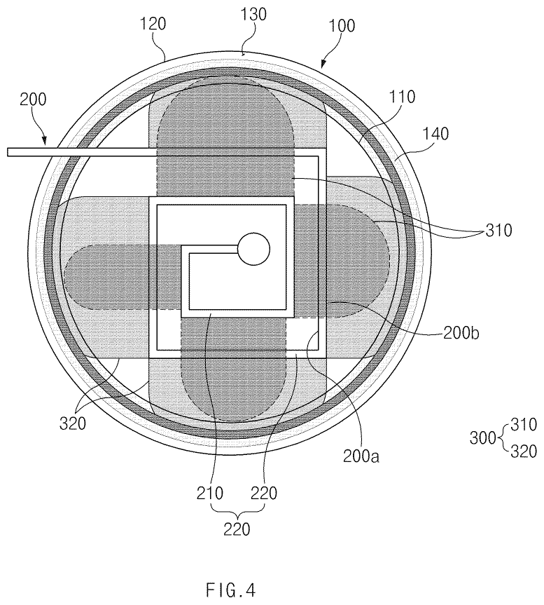

With reference to FIG. 4, according to an example embodiment of the present disclosure, the radiation-blocking member 300 may include a first blocking member 310 connected to the first spiral pipe portion 210 and stacked to be tightly attached to an inner surface of the thermal insulator 140 that faces the inner container 110, and a second blocking member 320 connected to the second spiral pipe portion 220 and stacked to be tightly attached to an outer surface of the thermal insulator 140.

The first blocking member 310 and the second blocking member 320 may be made of various materials capable of blocking radiant heat and having thermal conductivity. An embodiment of the present disclosure is not restricted or limited by the type and properties of the radiation-blocking member 300.

According to an example embodiment of the present disclosure, the first blocking member 310 and the second blocking member 320 may each be configured as thermally conductive foil (e.g., metal foil) with a very small thickness (e.g., several to several tens of micrometers (μm)).

According to an example embodiment of the present disclosure, foil made of high-purity silver or copper may be used as the first blocking member 310 and the second blocking member 320.

The first blocking member 310 and the second blocking member 320 may have various structures in accordance with required conditions and design specifications. An embodiment of the present disclosure is not restricted or limited by the structure and shape of the first blocking member 310 and the second blocking member 320.

For example, the first blocking member 310 and the second blocking member 320 may each have a continuous band shape in the longitudinal direction of the inner container 110. In particular, the first blocking member 310 and the second blocking member 320 may each have a length (a length in the longitudinal direction) corresponding to the inner container 110.

In particular, the second blocking member 320 may be configured to overlap the first blocking member 310 to cover the first blocking member 310.

As described above, in an embodiment of the present disclosure, the first blocking member 310 may be connected to the inner surface of the thermal insulator 140, and the second blocking member 320 may be connected to the outer surface of the thermal insulator 140. Therefore, an embodiment of the present disclosure can obtain an advantageous effect of minimizing the penetration of radiant heat into the inner container 110 from the outer container 120, maximizing the utilization of the cold energy during the extraction of the cryogenic liquid, and enhancing the thermal insulation performance.

The second spiral pipe portion 220 can be connected to a downstream side of the first spiral pipe portion 210 (the cryogenic liquid is heated by heat exchange while moving along the first spiral pipe portion 210 and then moves along the second spiral pipe portion 220), such that the first blocking member 310 connected to the first spiral pipe portion 210 can have a relatively lower temperature than the second blocking member 320 connected to the second spiral pipe portion 220. According to an embodiment of the present disclosure, the first blocking member 310 may be connected to the inner surface of the thermal insulator 140, and the second blocking member 320 may be connected to the outer surface of the thermal insulator 140, such that relatively low-temperature cold energy may be transferred to the inner surface of the thermal insulator 140, and relatively high-temperature cold energy may be transferred to the outer surface of the thermal insulator 140 in response to a temperature gradient in a thickness direction of the thermal insulator 140 (a phenomenon in which a temperature of the outer surface of the thermal insulator 140 is higher than a temperature of the inner surface of the thermal insulator 140). Therefore, an embodiment of the present disclosure can obtain an advantageous effect of maximizing the utilization of the cold energy and further improving the thermal insulation performance during the extraction of the cryogenic liquid.

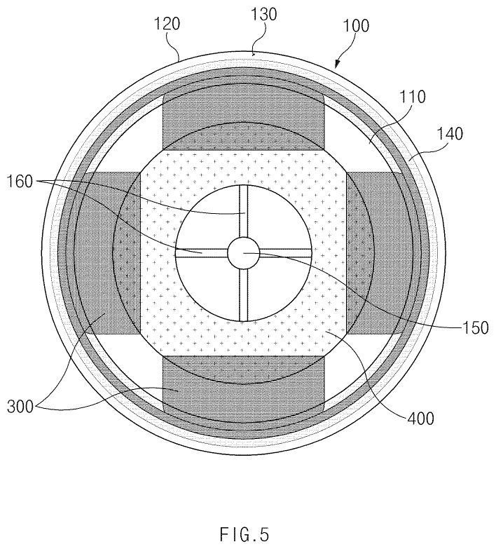

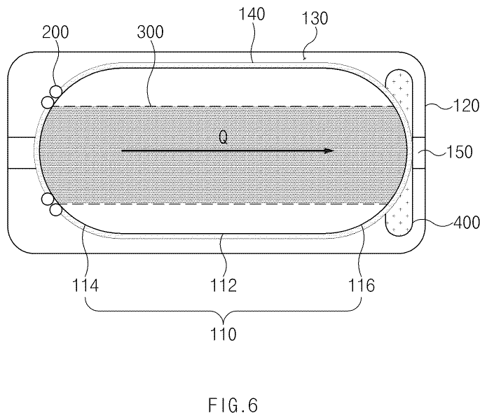

With reference to FIGS. 5 and 6, according to an example embodiment of the present disclosure, the cryogenic liquid storage apparatus 10 may include an energy storage member 400 connected to the radiation-blocking member 300, configured to exchange heat with the radiation-blocking member 300, and provided between the outer container 120 and the inner container 110.

The energy storage member 400 can be configured to store cold energy transferred along the radiation-blocking member 300.

The energy storage member 400 may be made of a typical energy storage material (e.g., metal) capable of temporarily storing cold energy transferred along the radiation-blocking member 300. An embodiment of the present disclosure is not restricted or limited by the material and properties of the energy storage member 400.

The energy storage member 400 may have various structures in accordance with required conditions and design specifications. An embodiment of the present disclosure is not restricted or limited by the structure and shape of the energy storage member 400.

According to an example embodiment of the present disclosure, the energy storage member 400 may be tightly attached to and surround an outer surface of at least any one of the first side part 114 and the second side part 116. Hereinafter, an example embodiment will be described in which the energy storage member 400 can be formed to have an approximately hollow ring shape and can be disposed to be tightly attached to the outer surface of the second side part 116.

In an embodiment of the present disclosure illustrated and described above, an example embodiment has been described in which the energy storage member 400 is provided at the end (the side part) of the inner container 110. However, according to another embodiment of the present disclosure, the energy storage member may be disposed on the cylinder part or other parts of the inner container.

As described above, in an embodiment of the present disclosure, the energy storage member 400 may be provided between the outer container 120 and the inner container 110, and the cold energy can be transferred along the radiation-blocking member 300 and may be stored in the energy storage member 400, such that the cold energy may be consistently stored even in case that the temperature of the radiation-blocking member 300 is sufficiently decreased. Further, even though the cryogenic liquid is not discharged (e.g., when a vehicle is parked), the thermal insulation performance of the storage container 100 may be stably maintained by using the cold energy stored in the energy storage member 400.

With reference to FIGS. 5 and 6, according to an example embodiment of the present disclosure, the cryogenic liquid storage apparatus 10 may include a support 150 configured to support the inner container 110 on the outer container 120.

The support 150 may have various structures capable of supporting the inner container 110 on the outer container 120. An embodiment of the present disclosure is not restricted or limited by the structure of the support 150.

According to an example embodiment of the present disclosure, the support 150 may support an end of at least any one of the first side part 114 and the second side part 116 on the outer container 120.

Hereinafter, an example embodiment will be described in which the support 150 can support the end of the second side part 116 on the outer container 120. Alternatively, the support 150 may be configured to support the cylinder part 112 or other portions of the inner container 110 on the outer container 120.

According to an example embodiment of the present disclosure, the energy storage member 400 may be supported by use of the support 150.

That is, according to the example embodiment of the present disclosure, the cryogenic liquid storage apparatus 10 may include a support member 160 having one end connected to the support 150, and the other end connected to the energy storage member 400. The energy storage member 400 may be supported by use of the support 150.

The support member 160 may have various structures capable of connecting the support 150 and the energy storage member 400. An embodiment of the present disclosure is not restricted or limited by the structure and shape of the support member 160.

For example, the support member 160 may be provided in the form of an approximately straight rod. The support member 160 may be provided as a plurality of support members 160 radially spaced apart from one another based on the support 150. Hereinafter, an example embodiment will be described in which four support members 160 can be connected to the support 150 while defining an approximately cross shape.

As described above, in an embodiment of the present disclosure, the energy storage member 400 may be supported by use of the support 150 configured to support the inner container 110 on the outer container 120. Therefore, an embodiment of the present disclosure can obtain an advantageous effect of stably maintaining the arrangement state of the energy storage member 400 and minimizing a structure and space for supporting the energy storage member 400.

According to an embodiment of the present disclosure described above, an embodiment of the present disclosure can obtain an advantageous effect of ensuring the thermal insulation performance of the storage container and improving the efficiency in storing the cryogenic liquid.

In particular, according to an embodiment of the present disclosure, an embodiment of the present disclosure can obtain an advantageous effect of ensuring the thermal insulation performance of the storage container by blocking an inflow of radiant heat into the inner container from the outer container and cooling the radiation-blocking member configured to block radiant heat.

Among other things, according to an embodiment of the present disclosure, an embodiment of the present disclosure can obtain an advantageous effect of improving the thermal insulation performance by transferring the cold energy of the cryogenic liquid, which moves along the extraction pipe, to the portion between the inner container and the outer container by use of the radiation-blocking member.

According to an embodiment of the present disclosure, an embodiment of the present disclosure can obtain an advantageous effect of simplifying the structure and improving the degree of design freedom and spatial utilization.

According to an embodiment of the present disclosure, an embodiment of the present disclosure can obtain an advantageous effect of suppressing an excessive increase in temperature (pressure) and excessive vaporization of the cryogenic liquid and suppressing an excessive increase in pressure of the inner container (excessive expansion of the inner container).

According to an embodiment of the present disclosure, an embodiment of the present disclosure can obtain an advantageous effect of ensuring durability and safety, minimizing a loss of hydrogen (the discharge amount of hydrogen), and maximally delaying a time point of a loss of hydrogen (extending a non-loss hydrogen storage period).

While example embodiments have been described above, the example embodiments are just illustrative and not intended to necessarily limit the present disclosure. It can be appreciated by those skilled in the art that various modifications and applications, which are not described above, may be made to an embodiment of the present embodiment without departing from the intrinsic features of the present embodiment. For example, the respective constituent elements specifically described in the example embodiments may be modified and then carried out. Further, it can be interpreted that the differences related to the modifications and applications can be included in the scopes of the present disclosure defined by the appended claims.

What is claimed is:

1. A cryogenic liquid storage apparatus comprising:
a storage container comprising an inner container configured to accommodate a cryogenic liquid, and an outer container configured to surround a periphery of the inner container;
an extraction pipe having a first-extraction-pipe end connected to the inner container, and a second-extraction-pipe end exposed to an outside of the outer container, the extraction pipe being configured to selectively extract the cryogenic liquid to the outside of the outer container; and
a radiation-blocking member connected to the extraction pipe, configured to transfer and receive heat to and from the extraction pipe, and provided between the inner container and the outer container.

2. The apparatus of claim 1, wherein the extraction pipe is connected to at least any one of two opposite inner-container ends of the inner container based on a longitudinal direction.

3. The apparatus of claim 1, comprising a thermal insulator provided between the inner container and the outer container and configured to surround an inner-container periphery of the inner container, wherein the radiation-blocking member is tightly attached to the thermal insulator.

4. The apparatus of claim 3, wherein the extraction pipe comprises:
a first spiral pipe portion connected to the inner container; and
a second spiral pipe portion continuously connected to a first-spiral-pipe-portion end of the first spiral pipe portion and configured to at least partially surround a first-spiral-pipe-portion periphery of the first spiral pipe portion.

5. The apparatus of claim 4, wherein the radiation-blocking member is connected to any one of or both of the first spiral pipe portion and the second spiral pipe portion.

6. The apparatus of claim 4, wherein the first spiral pipe portion and the second spiral pipe portion have a quadrangular spiral shape.

7. The apparatus of claim 4, wherein the first spiral pipe portion and the second spiral pipe portion have a circular spiral shape.

8. The apparatus of claim 4, wherein the radiation-blocking member comprises:
a first blocking member connected to the first spiral pipe portion and stacked on an inner surface of the thermal insulator that faces the inner container; and
a second blocking member connected to the second spiral pipe portion and stacked on an outer surface of the thermal insulator.

9. The apparatus of claim 1, wherein the extraction pipe comprises:
a non-surface-treated region; and
a surface-treated region having lower surface roughness than the non-surface-treated region, wherein the radiation-blocking member is connected to the surface-treated region.

10. The apparatus of claim 1, wherein the radiation-blocking member comprises thermally conductive foil.

11. The apparatus of claim 1, wherein the radiation-blocking member is continuously provided in a longitudinal direction of the inner container.

12. The apparatus of claim 1, comprising an energy storage member connected to the radiation-blocking member, configured to transfer and receive heat to and from the radiation-blocking member, and provided between the outer container and the inner container.

13. The apparatus of claim 12, wherein the inner container comprises:
a cylinder part;
a first side part provided at a first-inner-container end of the cylinder part and having a first dome shape; and
a second side part provided at second-inner-container end of the cylinder part and having a second dome shape, wherein the energy storage member is configured to surround an outer surface of any one of or both of the first side part and the second side part.

14. The apparatus of claim 13, comprising a support configured to support the inner container on the outer container.

15. The apparatus of claim 14, wherein the support is configured to support a side-part end of any one of or both of the first side part and the second side part, on the outer container.

16. The apparatus of claim 15, comprising a support member having a first-support-member end connected to the support, and a second-support-member end connected to the energy storage member.

17. The apparatus of claim 15, wherein the storage container comprises a vacuum thermal insulation layer defined between the inner container and the outer container.

18. A cryogenic liquid storage apparatus comprising:
a storage container comprising an inner container configured to accommodate a cryogenic liquid, and an outer container configured to surround a periphery of the inner container, wherein a vacuum thermal insulation layer is defined between the inner container and the outer container;
an extraction pipe having a first-extraction-pipe end connected to the inner container, and a second-extraction-pipe end exposed to an outside of the outer container, the extraction pipe being configured to selectively extract the cryogenic liquid to the outside of the outer container, wherein the extraction pipe comprises a first spiral pipe portion connected to the inner container, and wherein the extraction pipe comprises a second spiral pipe portion continuously connected to a first-spiral-pipe-portion end of the first spiral pipe portion and configured to at least partially surround a first-spiral-pipe-portion periphery of the first spiral pipe portion; and
a radiation-blocking member connected to the extraction pipe, configured to transfer and receive heat to and from the extraction pipe, and provided between the inner container and the outer container, wherein the radiation-blocking member is connected to any one of or both of the first spiral pipe portion and the second spiral pipe portion.

19. The apparatus of claim 18, further comprising:
an energy storage member connected to the radiation-blocking member, configured to transfer and receive heat to and from the radiation-blocking member, and provided between the outer container and the inner container; and
a support configured to support the inner container on the outer container,
wherein the radiation-blocking member comprises:
a first blocking member connected to the first spiral pipe portion and stacked on an inner surface of a thermal insulator that faces the inner container, and
a second blocking member connected to the second spiral pipe portion and stacked on an outer surface of the thermal insulator, wherein the radiation-blocking member is continuously provided in a longitudinal direction of the inner container, and
wherein the inner container comprises:
a cylinder part,
a first side part provided at a first-inner-container end of the cylinder part and having a first dome shape, and
a second side part provided at second-inner-container end of the cylinder part and having a second dome shape, wherein the energy storage member is configured to surround an outer surface of any one of or both of the first side part and the second side part.

20. A cryogenic liquid storage apparatus comprising:
a storage container comprising an inner container configured to accommodate a cryogenic liquid, and an outer container configured to surround a periphery of the inner container, wherein a vacuum thermal insulation layer is defined between the inner container and the outer container;
an extraction pipe having a first-extraction-pipe end connected to the inner container, and a second-extraction-pipe end exposed to an outside of the outer container, the extraction pipe being configured to selectively extract the cryogenic liquid to the outside of the outer container, wherein the extraction pipe comprises a first spiral pipe portion connected to the inner container, and wherein the extraction pipe comprises a second spiral pipe portion continuously connected to a first-spiral-pipe-portion end of the first spiral pipe portion and configured to at least partially surround a first-spiral-pipe-portion periphery of the first spiral pipe portion;
a radiation-blocking member connected to the extraction pipe, configured to transfer and receive heat to and from the extraction pipe, and provided between the inner container and the outer container, wherein the radiation-blocking member is connected to any one of or both of the first spiral pipe portion and the second spiral pipe portion;
an energy storage member connected to the radiation-blocking member, configured to transfer and receive heat to and from the radiation-blocking member, and provided between the outer container and the inner container;
a support configured to support the inner container on the outer container; and
a support member having a first-support-member end connected to the support, and a second-support-member end connected to the energy storage member,
wherein the radiation-blocking member comprises:
a first blocking member connected to the first spiral pipe portion and stacked on an inner surface of a thermal insulator that faces the inner container, and
a second blocking member connected to the second spiral pipe portion and stacked on an outer surface of the thermal insulator, wherein the radiation-blocking member is continuously provided in a longitudinal direction of the inner container, and
wherein the inner container comprises:
a cylinder part,
a first side part provided at a first-inner-container end of the cylinder part and having a first dome shape, and
a second side part provided at second-inner-container end of the cylinder part and having a second dome shape, wherein the energy storage member is configured to surround an outer surface of any one of or both of the first side part and the second side part, wherein the support is configured to support a side-part end of any one of or both of the first side part and the second side part, on the outer container.
